(19) United States
(12) Patent Application Publication
(10) Pub. No.: US 2026/0172540 A1
(43) Pub. Date: Jun. 18, 2026

(54) CONTENT DISPLAY BASED ON SPATIAL INFORMATION

(71) Applicant: Google LLC, Mountain View, CA (US)

(72) Inventors: Tianlu Tang, San Francisco, CA (US); Patrick Hackett, San Francisco, CA (US)

(21) Appl. No.: 18/985,512

(22) Filed: Dec. 18, 2024

(51) Int. Cl. H04N 13/383; H04N 13/111; H04N 13/344; H04N 13/398

(52) U.S. Cl. CPC H04N 13/383; H04N 13/111; H04N 13/344; H04N 13/398; G02B 2027/0178; G06F 3/013; G06F 3/0346; G06F 3/04815; G06T 19/006; G06T 2219/024; G06V 10/25

(57) ABSTRACT

According to at least one implementation, a method includes identifying a region in a physical environment and causing display of content on a device in a first configuration in response to the device being in the region. The method further includes identifying a movement of the device outside of the region and in response to the movement, causing display of the content on the device in a second configuration.

### BACKGROUND

An extended reality (XR) device incorporates a spectrum of technologies that blend physical and virtual worlds, including virtual reality (VR), augmented reality (AR), and mixed reality (MR). These devices immerse users in digital environments, either by blocking out the real world (VR), overlaying digital content onto the real world (AR), or blending digital and physical elements seamlessly (MR). XR devices include headsets, glasses, or screens equipped with sensors, cameras, and displays that track the movement of users and their surroundings to deliver immersive experiences across various applications such as gaming, on-the-go computing, education, healthcare, and industrial training.

### SUMMARY

This disclosure relates to systems and methods for defining (e.g., formatting or configuring) the display of content by a device based on spatial information, such as movement and orientation of a device. In at least one implementation, a computing device, such as an XR device or another wearable device, is configured to identify a region in the physical environment and display content in a first configuration when a user of the device is in the region. In some implementations, the user can request the display of content in the first configuration, the first configuration including a first size on the display, location on the display, opacity, or some other display configuration. In response to the request, the device can display content in the first configuration when the device is in the region. The region can be defined at least in part based on spatial information for the environment determined from one or more sensors. When the device vacates the first region, the device can be configured to transition from the first configuration to a second configuration for the content. In some examples, the second configuration can include a different format. In some examples, the second configuration can include a different size than the first configuration. In some examples, the second configuration can include a display location different from the first configuration. In some examples, the second configuration can include a different orientation than the first configuration. In at least one example, the second configuration can display the content in a smaller size than the first configuration.

In some aspects, the techniques described herein relate to a method including: identifying a region in a physical environment; causing display of content on a device in a first configuration in response to the device being in the region; identifying a movement of the device outside of the region; and in response to identifying the movement of the device outside of the region, causing display of the content on the device in a second configuration.

In some aspects, the techniques described herein relate to a computing apparatus including: at least one processor; a computer-readable storage medium operatively coupled to the at least one processor; and program instructions stored on the computer-readable storage medium that, when executed by the at least one processor, cause the at least one processor to execute operations, the operations including: identifying a region in a physical environment; causing display of content on a device in a first configuration in response to the device being in the region; identifying a movement of the device outside of the region; and in response to identifying the movement of the device outside of the region, causing display of the content on the device in a second configuration.

In some aspects, the techniques described herein relate to a computer-readable storage medium having program instructions stored thereon that, when executed by at least one processor, cause the at least one processor to execute operations, the operations including: causing display of content in a first configuration on a device; identifying a location associated with the device; identifying a gaze associated with a user of the device; determining that the location and the gaze satisfy at least one criterion; and in response to the location and the gaze satisfying the at least one criterion, causing display of the content in a second configuration in place of the first configuration.

The accompanying drawings and the description below outline the details of one or more implementations. Other features will be apparent from the description, drawings, and claims.

### BRIEF DESCRIPTION OF THE DRAWINGS

FIG. 1 illustrates a computing environment to configuration the display of content based on user movement according to an implementation.

FIG. 2 illustrates a method of operating a device to configuration the display of content based on user movement according to an implementation.

FIG. 3 illustrates an operational scenario of changing the configuration of content based on user movement according to an implementation.

FIG. 4 illustrates an operational scenario of changing the configuration of content based on user movement according to an implementation.

FIG. 5 illustrates an operational scenario of changing the configuration of content based on user movement and gaze according to an implementation.

FIG. 6 illustrates an operational scenario of changing the configuration of content based on user movement and gaze according to an implementation.

FIG. 7 illustrates a method of transitioning between content display configurations according to an implementation.

FIG. 8 illustrates an operational scenario of selecting a display configuration according to an implementation.

FIG. 9 illustrates an operational scenario of changing the content configuration based on user gestures according to an implementation.

FIG. 10 illustrates a method of operating a device to change the configuration of content based on user gestures according to an implementation.

FIG. 11 illustrates a computing system according to an implementation.

### DETAILED DESCRIPTION

Computing devices, such as wearable devices and extended reality (XR) devices, provide users with an effective tool for gaming, on-the-go computing, training, education, healthcare, and more. An XR device merges the physical and virtual worlds, encompassing virtual reality (VR), augmented reality (AR), and mixed reality (MR) experiences. These devices usually include headsets or glasses equipped with sensors, cameras, and displays that track users'movements and surroundings, allowing them to interact with digital content. XR devices offer immersive experiences by either completely replacing the real world with a virtual one (VR), overlaying digital information onto the real world (AR), or seamlessly integrating digital and physical elements (MR). Input to XR devices may be provided through physical gestures, voice commands, controllers, and eye movements. Users interact with the virtual environment by manipulating objects, navigating menus, and triggering actions using these input methods, which are translated by the device's sensors and algorithms into corresponding digital interactions within the XR space. However, at least one technical problem exists in managing the display of content based on user activities, movement, and the spatial information of the physical environment.

As at least one technical solution, a device is configured to identify a region in a physical environment and display content on the device in a first configuration in response to the device being in the region. As an example, a user of the device can request to view a video, a game, or some other content on the display of the device in a first configuration. In response to the request, the device can be configured to identify a region (e.g., physical area) within the physical environment suitable for providing the content in the first configuration. In some implementations, the device can be configured to identify spatial information about the physical environment through sensors, cameras, and algorithms. The device can be configured to use depth sensors, such as Light Detection and Ranging (LiDAR) or structured light, to measure distances to objects in the environment. Cameras capture images that are processed by the device using computer vision techniques to identify and track features, surfaces, and objects. Inertial measurement units (IMUs) provide data on the device's orientation and movement. The device can be configured to construct a map of the environment by integrating these data sources, enabling accurate spatial awareness and interaction within the virtual or augmented experience. In some examples, the device can be configured to use the spatial information to determine the region available to provide the content in the first configuration. This region can include a seating area, such as a couch, a segment of the room or other physical environment, or some other region. In at least one implementation, the device can determine a region around the user at the time of request. For example, a three-foot region around the user at the time of the request.

In some implementations, the first configuration can include a first size on the display of the device (e.g., a first resolution), a first location on the display of the device, a first opacity of the content on the device (i.e., the ability to view the physical space through the content), or some other configuration. In some examples, the first configuration can provide the content in a first format. In some implementations, the first configuration may comprise a first level of immersion, including VR immersion in some examples. VR immersion can be provided by a stereoscopic three-dimensional (3D) view that tracks the user's movements in real-time, creating the illusion of being present in a virtual environment. In some implementations, the device can display the content on a physical object (e.g., a wall) and provide additional effects, such as lighting and sound, to provide immersion into the displayed content.

After displaying the content in the first configuration, the device can further be configured to identify a movement of the device outside of the region and cause display of the content on the device in a second configuration in response to identifying the movement of the device outside of the region. In at least one implementation, the device can determine a spatial region (e.g., area on the floor) associated with providing the content in a first configuration.

When the user's movement takes the device and/or user outside of the spatial region, then the device can be configured to provide the content in a second configuration. The second configuration can comprise a different size on the display of the device than the first configuration, a different location on the display of the device than the first configuration, a different quantity of opacity associated with the content than the first configuration, or some other difference in configuration (e.g., format) from the first configuration. For example, an XR device can display content in a first configuration that includes a first size and is overlaid on a first anchor (e.g. a wall of the user's environment). The device can then determine when the device leaves a region associated with the first configuration and transition to a second configuration for the content when the device (or user) leaves the region. The second configuration can include a smaller-sized display of the content and may move the content from the first location on the display, such as the center of the display, to a corner or an off-center location of the display.

Like the operations described above, the device can further be configured to determine when the device enters the region from outside the region. In response to reentering the region, the content can be displayed in the first configuration, and the content in the second configuration paused, stopped, or otherwise removed from the display on the device. As a technical effect, in at least one example, the user can be presented with a larger view of the content inside the region and a smaller, less distracting view outside the region.

In some technical solutions, in addition to considering the devices location relative to the region, the device can further be configured to monitor the gaze associated with the user. Gaze monitoring can involve embedded eye-tracking sensors that use infrared light to illuminate the eyes and cameras to capture the reflections. The system can use the position and movement of the user's eyes to determine their point of focus within the virtual or augmented environment. Algorithms process this data to adjust the display, enhance interactivity, and improve user experience by enabling various display and input features. In some implementations, the device can further include head motion and orientation sensors to further determine the directionality associated with the gaze. These sensors can include accelerometers, gyroscopes, and sometimes magnetometers, which track the orientation and movement of the head. This information can be combined with eye tracking to determine the gaze of the user.

From the gaze determination and the location of the user relative to the region, the device can be configured to determine whether to display the content in the first configuration or the second configuration. In at least one implementation, the device can be configured to determine whether the user's gaze is within a threshold angle for displaying the first content and the user is within the region. If the user's gaze is within the threshold angle and the user (i.e., device) is within the region, then the content is displayed in the first configuration. Otherwise, the device is configured to display the content in the second configuration. As an example, the first configuration can display content overlaid on a wall of the room, wherein the content is presented in a first configuration (e.g., covering a large portion of the wall). Based on the user's gaze and the movement of the device, the device can be configured to determine when to transition to a second configuration, wherein the second configuration can provide the content as a smaller size (i.e., using less of the field of view for the user) and can relocate the content to a different portion of the user's field of view.

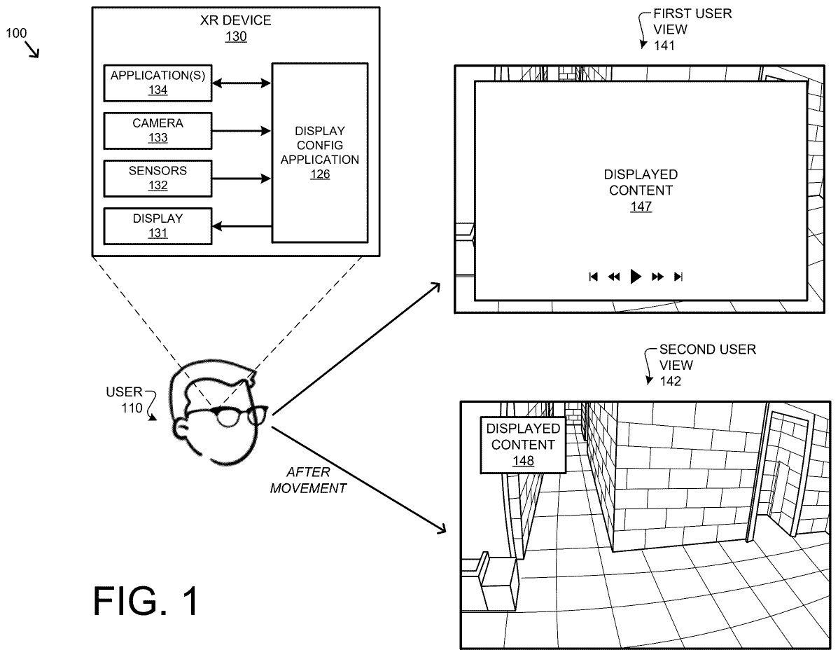

FIG. 1 illustrates a computing environment 100 to configuration the display of content based on user movement according to an implementation. Computing environment 100 includes user 110, XR device 130, first user view 141, and second user view 142. XR device 130 includes display configuration (config) application 126, display 131, sensors 132, camera 133, and application(s) 134. First user view 141 includes displayed content 147 and second user view 142 includes displayed content 148.

In computing environment 100, XR device 130 identifies a region associated with playing content in a first configuration, which is demonstrated in first user view 141. When the user is located within the region, such as a region within a room, XR device provides displayed content 147. XR device 130 is further configured to monitor the movement associated with the device and determine when the device vacates the region. When XR device 130 vacates the region (e.g., after movement), then second user view 142 is provided with displayed content 148. Displayed content 148 uses less of the user perspective and moves the location of the content on the display and the field of view. In some implementations, by reducing the size of the content and moving the location of the content, the user is able view a larger portion of the physical area. In some examples, XR device 130 can allow the user to view the physical world by using cameras or sensors to capture real-world images and overlaying digital information onto them.

In some examples XR device 130 can passthrough the physical world using a transparent display allows users to see the physical world directly through the screen, onto which digital images and information are overlaid.

XR device 130 includes display 131 that can use advanced optics, like transparent waveguides or holographic lenses, to overlay digital images onto the real world, allowing users to see both simultaneously. High-resolution micro-displays generate these digital images, which are then projected through or reflected by the optical system into the user's field of view. In some implementations, display 131 may also display the physical world via cameras that capture the physical world and project the physical world with overlaid digital content for user 110. XR device 130 further includes sensors 132 and camera 133 that capture real-world images and track the user's movements and environment, enabling accurate placement and interaction of digital content within the physical space. These components also facilitate features like gesture recognition and spatial mapping, enhancing the overall immersive experience for user 110. XR device 130 also includes application(s) 134, which may include virtual reality games, augmented reality navigation apps, mixed reality design tools, content playback applications, and immersive training simulations that are displayed via display 131. However, at least one technical problem exists in determining how the content is displayed for the user to ensure safety in association with user movement.

Display configuration application 126 is provided to provide at least one technical solution to the one or more technical problems. It is configured to use the data from camera 133 and sensors 132 to determine when to transition from displayed content 147 to displayed content 148. Display configuration application 126 can be configured to determine when the data received from the sensors and camera satisfy one or more criteria and update the display of content from application(s) 134 on display 131. In some implementations, display configuration application 126 can be configured to display requested content in a first configuration represented as displayed content 147 when user 110 is located within a region.

In some examples, display configuration application 126 is configured to determine spatial information for the physical environment and determine the available region for user 110 to view the content in the first configuration. Display configuration application 126 and XR device 130 can determine spatial information using a combination of cameras, depth sensors, and motion tracking technologies. These components map the physical environment by capturing images and depth data, which are then processed to create a 3D model of the surroundings. This model allows the device to understand spatial relationships and track the user's position and movements within the environment. In some implementations, display configuration application 126 can select a region from the spatial area that is within a threshold distance or radius from the time of request. In other implementations, the device can determine an available region for the user based on objects identified in the spatial information, including chairs, couches, tables, or other objects that could pose a risk to user 110. The region can then correspond to areas of the physical environment that would prevent the user from encountering obstacles.

Once the region is defined, display configuration application 126 can be configured to determine when XR device 130 vacates the region. When the region is vacated, display configuration application 126 can update displayed content to displayed content 148 provided in second user view 142. Displayed content 148 includes a smaller size and a different location than displayed content 147. In some implementations, the second configuration can permit a larger field of view associated with the physical environment for the user. The technical effect permits the device to adjust the display of content, enabling the user to view the surrounding physical environment when moving away from a defined region.

In some implementations, display configuration application 126 identifies when the user approaches the edge of the available region (i.e., the boundary). Based on the proximity to the region's edge, display configuration application 126 can initiate the transition from displayed content 147 to displayed content 148. In some examples, the transition can be gradual as the user approaches the edge of the region. The gradual transition can include changing the size of the content as the user approaches the edge, changing the location of the content as the user approaches the edge, changing the amount of the physical world visible to the user, or some other gradual transition. For example, the content can be provided at a first size as the user is a first distance from the edge. As the user moves closer to the edge, the content can be provided at a second size that is smaller than the first size. As at least one technical effect, the user can gradually be transitioned from the first configuration to the second configuration, removing an abrupt transition between the configurations.

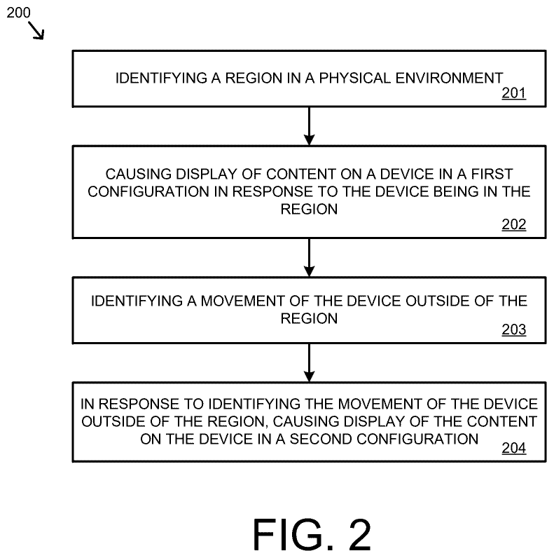

FIG. 2 illustrates a method 200 of operating a device to configuration the display of content based on user movement according to an implementation. The steps of method 200 are described below with reference to systems and elements of computing environment 100 of FIG. 1. However, method 200 can be implemented using other types of devices, such as head-mounted devices.

Method 200 includes identifying a region in a physical environment at step 201 and causing display of content on a device in a first configuration in response to the device being in the region at step 202. In some implementations, the device can define the region using spatial information about the physical environment. The device can be configured to determine spatial information using a combination of cameras, depth sensors, and motion-tracking technologies. These components map the physical environment by capturing images and depth data, which are then processed to create a 3D model of the surroundings. This model allows the device to understand spatial relationships and track the user's position and movements within the environment. Once the spatial information is determined, then a region can be defined in association with the first configuration. As an illustrative example, user 110 can generate a request to display content (e.g., movie, game, and the like). In response to the request, the device can determine a region within the physical environment available to display the first content. For example, in a living room, XR device 130 can identify spatial information associated with a seating area (chairs, tables, and the like) to determine a safe location for the user to view the content in the first configuration. In some examples, the spatial information can be compared using a model of known environments (and available first content areas) to define the available region for the first content. Similarities between the current physical environment can be compared to known environments to dictate the region available for the first content.

In other implementations, the user can use gestures or gaze to define the available region for the first content. The device can be configured to use one or more sensors to identify user intent, indicating the region associated with the first content. For example, the user can provide a pointing or other gesture that outlines an area on the floor available for the first content. The gestures can be tracked using a combination of camera-based sensors and machine-learning algorithms. These sensors capture the position and movement of the user's extremities (e.g., arms), while the algorithms interpret the data to recognize specific gestures in relation to the physical environment (e.g., depth, objects, and the like).

Method 200 further includes identifying a movement of the device outside of the region at step 203. In some implementations, the device's movement can be tracked using a combination of inertial measurement units (IMUs) and camera-based tracking. The IMUs detect changes in acceleration and rotation, while the camera-based tracking maps the environment to track the user's position relative to known landmarks. The IMUs can be tracked by measuring acceleration, gyroscopic rotation, and sometimes magnetic field data to determine changes in orientation and movement. From this sensor information, the device can determine when the user leaves the allocated region.

In response to identifying that the device moves outside of the region, method 200 further includes causing display of the content on the device in a second configuration at step 204. In some implementations, the second configuration comprises a smaller size, a different location, a different layer of immersion (e.g., overlaying content on an object on a wall as first configuration and placing the content in a smaller portion of the display as the second configuration), a different opacity, or some other difference in configuration. As an example, a device can display content overlaid on a physical wall of the user's room (such as mimicking a large television on the wall) as part of the first configuration. When the user vacates the region associated with the first configuration, the device can transition to a second configuration that places the device in a smaller configuration and a different location (e.g., bottom corner of the user's field of view).

Although demonstrated in the previous example using location to determine whether to play content in a first or second configuration, the device can be configured to use alternative information to select the configuration of the content. In at least one implementation, the device can monitor the gaze of the user to determine whether one or more criteria are met for the first configuration. The device can be configured to monitor user gaze using a combination of eye-tracking cameras and sensors. These cameras, typically located near the lenses, capture high-speed images of the eyes and track the movement and position of the pupils. Advanced algorithms then process these images to determine where the user is looking by analyzing the direction and focus of the gaze.

In some implementations, in addition to changing the visual configuration of the content, the device can be configured to adjust the sound associated with the content based on the movement of the user. For example, when providing the content in the first configuration, the content can be provided at a first sound level, and when providing the content in the second configuration, the content can be provided at a second level. The second level can be less than the first level in some examples. The lower sound level associated with the second configuration can permit the user to listen to external sounds, such as voices or alerts, that are not part of the content.

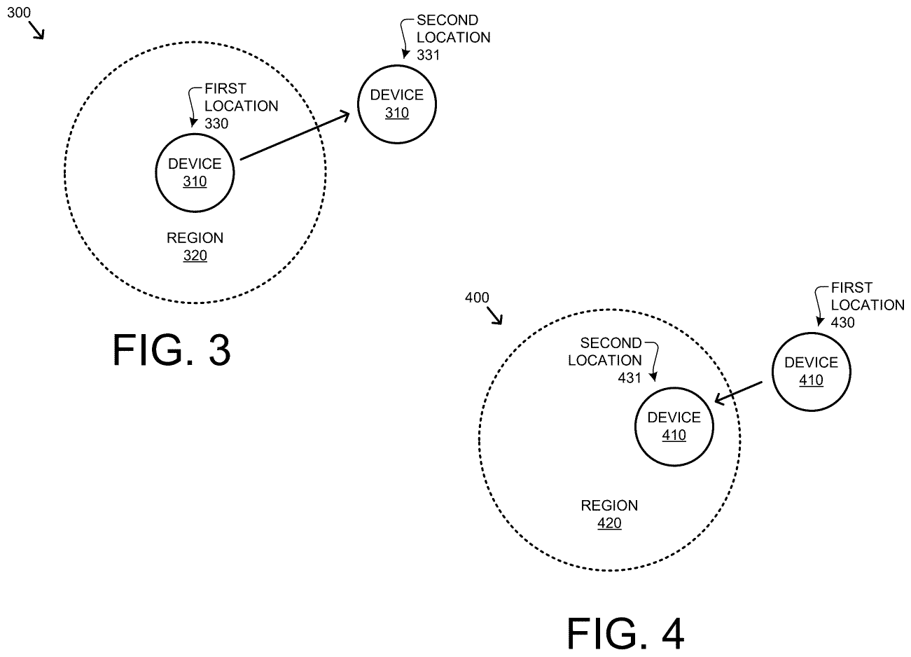

FIG. 3 illustrates an operational scenario 300 of changing the configuration of content based on user movement according to an implementation. Operational scenario 300 includes device 310, region 320, first location 330, and second location 331.

In operational scenario 300, device 310, which represents a wearable device (i.e., XR device), moves outside of region 320. Device 310 determines its location using a combination of sensors and technologies. Device 310 can employ cameras, accelerometers, gyroscopes, and sometimes LIDAR or depth sensors to map the surrounding environment and track movements in real-time. This process allows the device to understand its position and orientation by analyzing visual data and changes in sensor readings. The device can compare this information with a virtual map of the environment, enabling accurate spatial awareness and positioning. In some implementations, region 320 is defined by the user of the device and corresponds to a first configuration for content. In some implementations, region 320 is established by device 310 based on information gathered about the physical environment using the aforementioned sensors. For example, device 310 can be configured to identify a region that is available (and safe) to provide content in a first configuration. The first configuration can comprise a first size, a first resolution, a first location on the display, or some other configuration for the content. For example, content, such as a movie, can be displayed as a large overlay on the wall of the user's physical environment. Region 320 can correspond to locations within the physical environment (e.g., a sitting area) to display the content in the first configuration. Once the user vacates region 320 as demonstrated by second location 331, device 310 can be configured to display the content in a second configuration. The second configuration may comprise a different size, display location, resolution, or some other different display configuration (e.g., format) from the first. In at least one implementation, the second configuration may reduce the size of the content and move the content to a peripheral portion of the display. Advantageously, the configuration change provides safety when the user vacates region 320. The system can permit the first configuration to resume or return when the user returns to region 320. Thus, when the return of device 310 to region 320 occurs, device 310 can display the content in the first configuration.

In some implementations, the transition from the first configuration to the second configuration can be gradual. The transition can gradually transition the size, the location, and the like as the user approaches the edge of region 320. As a result, rather than abruptly transitioning between the different formats, the user can gradually be transitioned between formats.

FIG. 4 illustrates an operational scenario 400 of changing the content configuration based on user movement according to an implementation. Operational scenario 400 includes device 410, region 420, first location 430, and second location 431.

In operational scenario 400, device 410 starts in first location 430, which is outside of region 420. Device 410 can be configured to employ cameras, accelerometers, gyroscopes, and sometimes LIDAR or depth sensors to map the surrounding environment and track movements associated with the device's user. This process allows the device to understand its position and orientation by analyzing visual data and changes in sensor readings. The device can compare this information with a virtual map of the environment, enabling accurate spatial awareness and positioning. Here, device 410 is configured to display content using a first configuration when the device is outside of region 420 and display the content using a second configuration when the device is inside region 420. The different configurations can present the content in different resolutions, different locations on the display, or some other different configuration. For example, when outside of region 420, the content can be provided at a first size on the peripheral of the device's display. However, when inside of region 420, the content can be provided at a second size and in a different portion of the display (e.g., centered or overlayed on a physical object, such as a wall). Thus, when the device moves from first location 430 to second location 431, device 410 can be configured to display the content at a larger size than the first configuration outside of region 420.

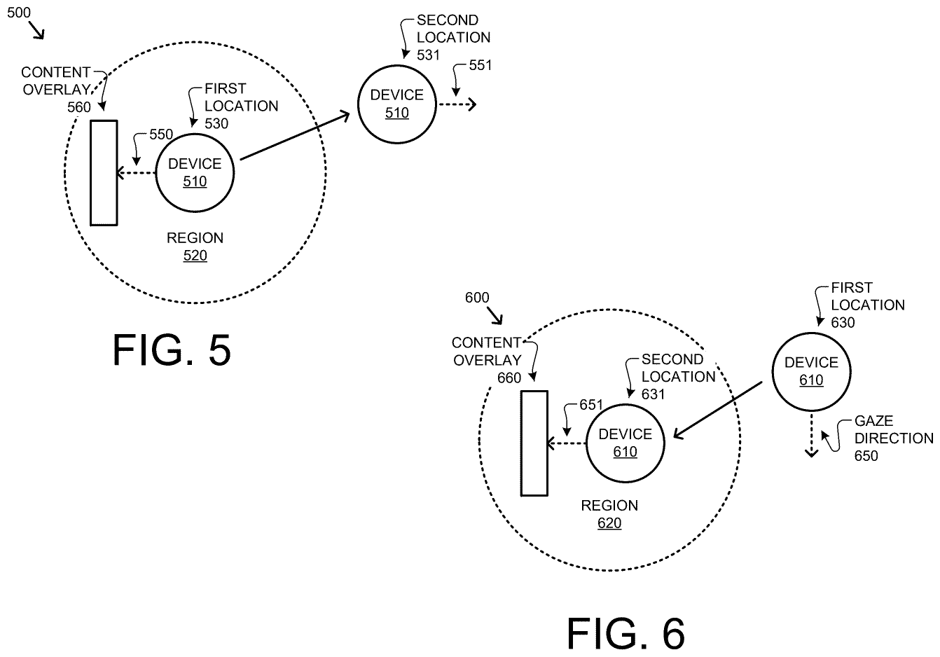

FIG. 5 illustrates an operational scenario 500 of changing the configuration of content based on user movement and gaze according to an implementation. Operational scenario 500 includes device 510, region 520, first location 530, second location 531, gaze direction 550, gaze direction 551, and content overlay 560.

In operational scenario 500, device 510 moves from first location 530 with gaze direction 550 to second location 531 with gaze direction 551. Device 510 monitors the location and the gaze of the user to determine when to transition from providing content in a first configuration associated with content overlay 560 to a second configuration. The second configuration may comprise a different size, a different display location, a different resolution, or some other configuration difference from the first configuration. In some implementations, device 510 is configured to determine when one or more criteria are satisfied to transition from the first configuration to the second configuration. The criteria can include a gaze angle relative to content overlay 560, a determination of whether device 510 is in region 520, or some other criterion, including combinations thereof.

As an example, a user of device 510 can request content be displayed or overlaid on content overlay 560. Content overlay 560 may comprise a wall, a window, or some other surface. Content can also be displayed without being overlaid on a physical surface in some examples but can be displayed for an orientation of the device (i.e., user point-of-view in one direction). The content can be provided in a first configuration, including a first size, first location on the display, and the like. Device 510 can be configured to monitor the user to determine the user's gaze and the location of device 510. Device 510 can be configured to determine gaze by tracking the position and movement of the user's eyes or head using sensors or cameras. This data is processed to identify where the user is looking within the virtual or augmented environment. Device 510 can track movement using a combination of sensors and technologies, such as accelerometers, gyroscopes, magnetometers, and external cameras or sensors. Accelerometers and gyroscopes measure the device's orientation and acceleration, allowing for the detection of rotational and linear movements. Magnetometers can provide compass direction, helping to correct orientation. Additionally, external cameras or sensors may be used for outside-in tracking, where the position of the device or controllers is tracked relative to a fixed external reference, or inside-out tracking, where the device's onboard sensors map the surrounding environment to determine movement. These data points can then be processed to provide accurate tracking of the user's position and movement. In some implementations, the cameras and sensors can also be used to define region 520 which corresponds to and permits content to be displayed in the first configuration. Region 520 can be a radius around the user, can be a region identified as safe for display in the first configuration (e.g., a sitting area), or can be some other region. In some implementations, device 510 determines a safe area, often referred to as a “play area” or “guardian system,” by using sensors and cameras to map the physical environment. The device can identify boundaries and other obstacles in the environment that correspond to transitions from the first configuration to a second configuration.

In operational scenario 500, device 510 identifies when the one or more criteria are satisfied in association with the user gaze and/or location of the device. When the criteria are satisfied (e.g., device 510 out of region 520 and gaze at an angle away from content overlay 560), device 510 can be configured to transition from the first configuration to the second configuration. The second configuration can include a smaller size than the first configuration, a different location on the display, or some other difference in configuration.

FIG. 6 illustrates an operational scenario 600 of changing the configuration of content based on user movement and gaze according to an implementation. Operational scenario 600 includes device 610, region 620, first location 630, second location 631, gaze direction 650, gaze direction 651, and content overlay 660.

In operational scenario 600, device 610 starts in first location 630 with gaze direction 650. Device 610 can be configured to monitor the gaze of the user and the location of the user and determine when the gaze and the location satisfy at least one criterion to transition content from a first configuration to a second configuration. Here, when the user is outside of region 620 and/or has gaze angle that is larger than a threshold from content overlay 660, the content can be displayed in a second configuration. The second configuration can comprise a first size, location on the display, or some other display configuration characteristic. Device 610 then determines when one or more criteria are identified to transition to the first configuration, including device 610 moving into region 620 and gaze direction 651 being within a threshold angle associated with content overlay 660. In response to satisfying the one or more criteria, device 610 can be configured to transition to a first configuration for the content and pause or stop the display of the content in the second configuration. In at least one implementation, the first configuration can comprise a different size and location on the display of device 610.

In some implementations, device 610 determines a region 620 for user activity associated with the first configuration by using a combination of sensors, cameras, and algorithms to map the physical environment. The device captures the layout and features of the surrounding area, identifying obstacles, boundaries, and available space. It then creates a virtual boundary (i.e., region 620), that transitions the content from the first configuration to the second configuration. This system ensures users can move and interact freely within the designated region 620 while minimizing the risk of collisions with real-world objects or people by adjusting the configuration of the content.

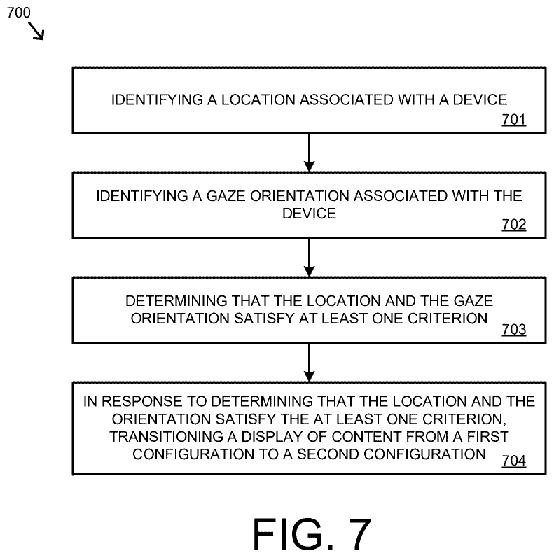

FIG. 7 illustrates a method 700 of transitioning between content display configurations according to an implementation. Method 700 can be implemented by an XR device or some other wearable device.

Method 700 includes identifying a location associated with a device at step 701 and identifying a gaze orientation associated with the device at step 702. In some implementations, the device determines its location in a physical environment using a combination of technologies, including sensors, cameras, and algorithms for spatial tracking. The device can utilize inside-out tracking, where cameras and sensors on the device scan the surrounding area to identify key features and create a map of the environment. The device can track its movement and orientation in real time by continuously updating this map and comparing it to the current view. Additionally, technologies like global positioning systems (GPS), inertial measurement units (IMUs), and Simultaneous Localization and Mapping (SLAM) algorithms can further refine the device's understanding of its position and movement within the space. Additionally, the device can be configured to determine the gaze orientation of the user using eye-tracking technology, which can involve infrared cameras and sensors. These components capture the movement and position of the user's eyes, tracking their direction in real time. The data collected can include the position of the pupils, eye movements, and sometimes the reflection patterns on the cornea. This information is processed by the device's software to calculate the point of gaze, allowing the device to understand where the user is looking within the virtual or augmented environment. In some examples, the device can further use accelerometers and other sensors to determine the position of the user's head orientation in the physical space. For example, the sensors and algorithms on the device can be used to determine whether the user is looking at a physical object (e.g., wall) or away from the physical object.

Method 700 further includes determining that the location and the orientation satisfy at least one criterion at step 703. The at least one criterion can include the device leaving a designated region associated with the display of content in a first configuration, can include the gaze angle exceeding an angle associated with the display of content in the first configuration, or can include some other criteria. As an example, the device can determine when the device leaves a region designated for the display of content in the first configuration. In response to determining that the location and gaze orientation satisfy the at least one criterion, method 700 provides for transitioning a display of content from a first configuration to a second configuration at step 704.

As an illustrative example, a user of a device may request to display content on the device, wherein the content is overlaid in a large configuration on a wall of the user's physical environment. In response to the request, the content can be displayed in a large configuration (i.e., first configuration) using the display of the device. After displaying the content in the large configuration, the device can be configured to monitor the device movement and the user's gaze to determine whether the content should be transitioned from the first configuration to the second configuration (i.e., at least one criterion is met), where the first configuration is paused or stopped and the second configuration is started. The second configuration may comprise a smaller display of the content, a display in a peripheral location on the display, or some other difference in the configuration or display format. In some implementations, the second configuration can permit the user to view a larger portion of the physical environment via pass-through cameras or transparent lenses on the device. As a technical effect, when the user of the device leaves the designated region, the user can view more of the surrounding physical environment, preventing undesirable collisions or other safety concerns.

In some implementations, the device can be configured to also determine when to transition from the second configuration to the first configuration. In at least one example, the device can monitor the gaze of the user and the location of the device and determine when the gaze and/or location satisfies at least one criterion associated with the transition. For example, the device can be configured to determine when the user's gaze is within a threshold angle for the first configuration and in a region associated with the first configuration. When the at least one criterion is satisfied, the device can transition from the second configuration to the first configuration. In some implementations, the device will stop the display of the content in the second configuration and initiate display of the content in the first configuration. In some implementations, the device can display the second configuration in a smaller size or a different location than the first configuration.

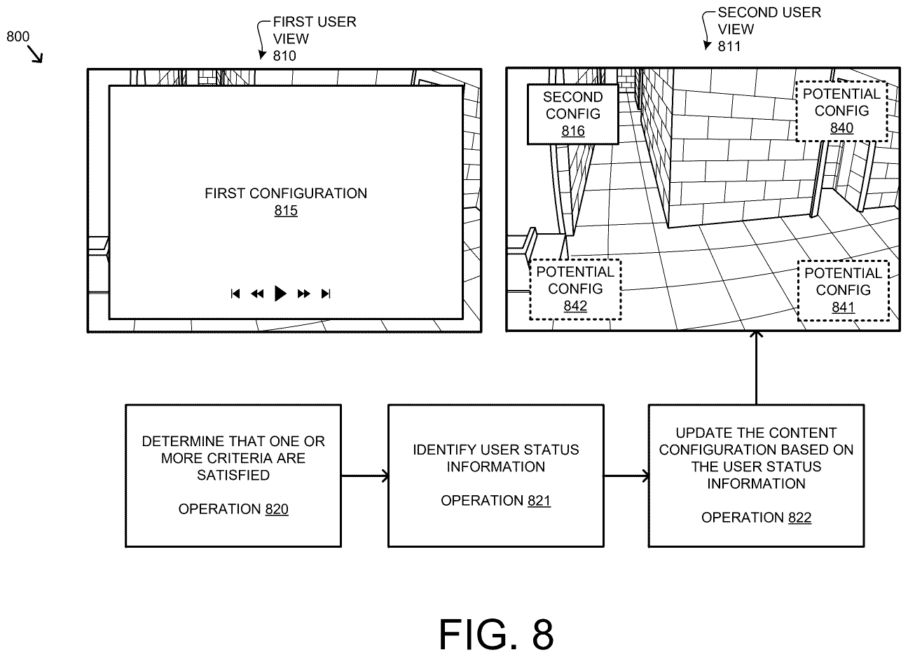

FIG. 8 illustrates an operational scenario 800 of selecting a display configuration according to an implementation. Operational scenario 800 includes first user view 810, second user view 811, first configuration 815, second configuration (config) 816, potential configurations (configs) 840-842, and operations 820-822. Operations 820-822 represent operations by a wearable device, such as an XR device, or XR device 130 of FIG. 1.

In operational scenario 800, a device performs operation 820 to determine that one or more criteria are satisfied associated with transitioning content from being displayed by the device in a first configuration to displaying content in a second configuration. The one or more criteria can include the user of the device (or the device itself) leaving a designated region associated with the first configuration, the user's gaze diverging from the content in the first configuration by a threshold amount or angle, or some other criteria, including combinations thereof. The device is further configured to provide operation 821, wherein operation 821 identifies user status information. The user status information can include the gaze of the user, movement and gestures of the user, or some other information associated with the gaze and movement of the user.

In some implementations, the device can monitor gaze and movement using a combination of sensors and tracking technologies. Eye-tracking sensors, typically embedded within the headset, detect the direction and focus of the user's gaze by capturing data on eye movements. These sensors use infrared light to illuminate the eyes and cameras to capture reflections, allowing the device to calculate the gaze direction. For tracking movement, XR devices utilize a mix of accelerometers, gyroscopes, and magnetometers to detect head and body motion. The cameras and sensors permit the device to determine focus areas for the user, such as moving objects, reading, and the like. For example, eye-tracking sensors and cameras can determine a gaze location for the user to determine an object in the physical space that the user is looking at.

The device further performs operation 822 to update the content configuration based on the user status information (i.e., the movement and gaze of the user). In some implementations, the device can determine a location, size, and the like as the update to the content configuration. As demonstrated in second user view 811, potential configurations 840-842 are included with second configuration 816, representing the selected configuration for the content. As an example, if the user status indicates user movement or gaze viewing the lower right portion of the display and the physical environment, the device can display second configuration 816 to provide the content at the periphery of the user's gaze.

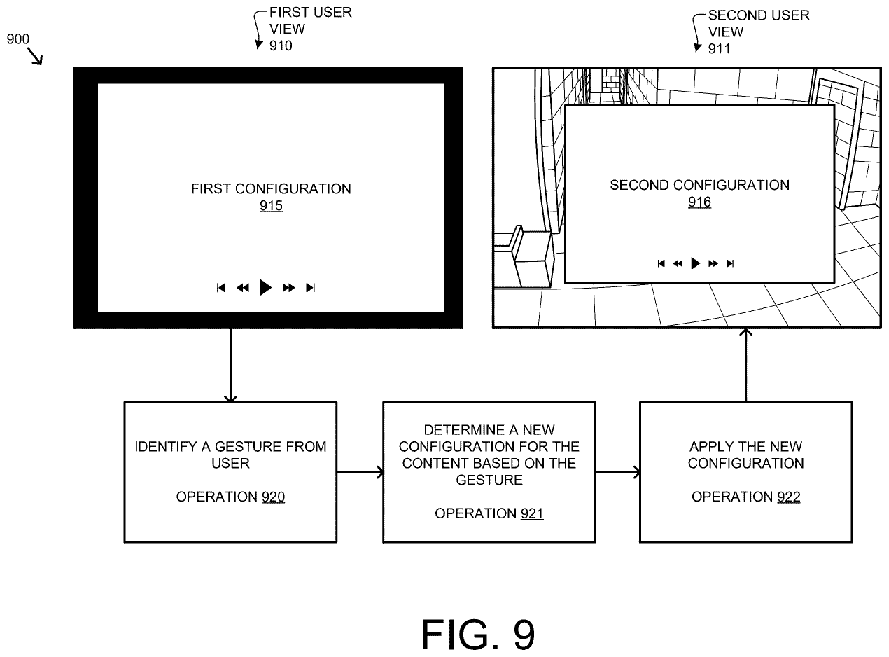

FIG. 9 illustrates an operational scenario 900 of changing the content configuration based on user gestures according to an implementation. Operational scenario 900 includes first user view 910, second user view 911, first configuration 815, second configuration 916, and operations 920-922.

In operational scenario 900, a user's perspective is demonstrated as first user view 910 with first configuration 915 for content. The content can include a video, a game, or other content. The content can be overlaid in first user view 910 by projecting digital imagery onto transparent lenses or screens in front of their eyes. Technologies like waveguides or reflective surfaces can direct light from a projector or display into the user's line of sight. The generated content is viewable and blocks at least a portion of the physical environment from the user's view. In first user view 910, the user is provided with a level of immersion that prevents the user from viewing the physical world. The first level of immersion can block a quantity of the physical environment, include a first number of visual effects, display the content at a first size, or provide some other type of immersion associated with the content. For example, when the user first requests to view a video, the device can display the content in first configuration 915, which corresponds to a first level of immersion for the user. The first level of immersion can comprise an AR immersion where the physical world is not visible through the lenses of the device.

While displaying the content in first configuration 915, a device can provide operation 920 that identifies a gesture from the user. The gesture can include air pinching, tapping, swiping, pointing, grabbing, holding up a palm, multi-finger swipe, or another gesture provided by an extremity associated with the user. For example, the user can give a pinching gesture to change the configuration from a first to a second type of immersion. In some examples, rather than identifying a gesture, the device can identify a voice command corresponding to a request to change the configuration from a first to a second type of immersion.

In response to identifying the gesture, the device can perform operation 921, which determines a new configuration for the content based on the gesture. In some examples, the new configuration provides a different type of immersion, where the different immersion can comprise a different size for the content, different visual effects (e.g., lighting or colors around a video or other content), or a different quantity of the physical environment visible through the lens of the device. Once determined, operation 922 applies the new configuration as second configuration 916 depicted in second user view 911. Here, second configuration 916 differs from first configuration 915 by reducing the size of the display of the content and permitting additional portions of the physical environment to be visible to the user. As a technical effect, the user can interact with or view objects in the physical environment in response to providing a gesture to change the content configuration.

In some implementations, different gestures can support different configurations for the content or different types of immersion. For example, if the user swipes left, the device can update the content with a first configuration, wherein the first configuration can include a first location, size, lighting effects, and the like. If the user swipes right, the device can update the content with a second configuration, wherein the second configuration includes one or more different attributes (lighting effects, size, location on display, etc.) than the first configuration. In some implementations, the user can cycle through multiple configurations using the same gesture. In some implementations, the user can return to or resume the original configuration using a different gesture. For example, the user can pinch to move from first configuration 915 to second configuration 916. The user can then use a swipe gesture to return to first configuration 915.

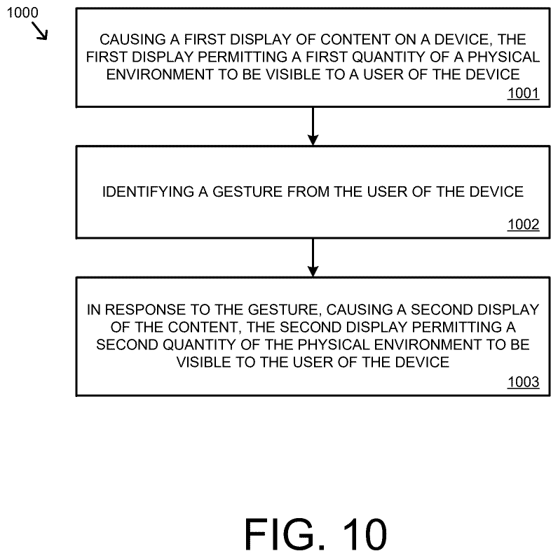

FIG. 10 illustrates method 1000 of operating a device to change the configuration of content based on user gestures according to an implementation. In some examples, the steps of method 1000 can be performed by a wearable device, such as an XR device.

Method 1000 includes causing (1001) a first display of content on a device, the first display permitting a first quantity of a physical environment to be visible to a user of the device. Method 1000 further includes identifying (1002) a gesture from a user of the device and, in response to the gesture, causing (1003) a second display of the content, the second display permitting a second quantity of the physical environment to be visible to the user of the device. In some implementations, the second display replaces the first display. In some implementations, the second display comprises a change in immersion for the user. In some implementations, the second display can provide the user with an AR or MR experience, while the first display can provide the user with a VR experience. As at least one technical effect, the user can first be provided with an experience with little or no view of the physical environment through the lenses of the device. Then, following a user gesture, the user can be provided with an experience that permits the user to view additional portions of the physical environment (via adjusting the size of the content, the lighting effects, the location, or another parameter associated with the content).

For example, a device can display a video for a user in a first configuration. The first configuration comprises a first size and effects that limit the view of the physical environment via the device's lens. In response to a user gesture (e.g., a swipe gesture), the device can transition to a second configuration for the content, the second configuration comprising one or more of a different size for the content, different effects around the content, a change in the amount of the physical environment visible to the user through the device, or some other change from the first configuration.

In some implementations, a device can be configured to transition from a first playback configuration to a second playback configuration based on gesture controls provided by the user. For example, a user may play content in a fully immersive display that includes a large playback size and prevents the physical world from being displayed to the user. The device can then be configured to monitor for a gesture that will change the immersion of the display. In changing the immersion, the device may be configured to permit at least a portion of the physical world to be visible through the device (e.g., through at least one lens on the device) and may reduce the playback size of the content in some instances. For example, rather than preventing the user from viewing the physical world, the device can be configured to permit at least a portion of the physical world to be viewable around the content. The technical effect permits the user to selectively change the display of content from a first state of immersion to a second state of immersion. The device may further be configured to adjust other immersion characteristics, including graphics around the content, audio of the content, or other characteristics to adjust the scale or state of immersion.

In some implementations, a device can be configured to provide a first display of content on a device, where the first display provides a first state of immersion. The first state of immersion can include a first size for the content and permit a first portion of the physical world to be viewed by the user (or none of the physical world in some examples). Once the first display is provided, the device can be configured to monitor for a gesture supplied by the user to change the immersion state from the first state of immersion to a second state of immersion. In response to identifying the gesture, the device can be configured to transition a second display of the content, the second display providing the second state of immersion. The second state of immersion may provide the content at a second size and/or permit the user to view a second portion of the physical world. In some implementations, the different states of immersion can include different content sizes, different quantities of the physical world visible via the display on the device, different graphics or visuals around the content, differences in audio (e.g., volume), or some other immersion characteristic.

In some implementations, the transition from the first state of immersion to the second state of immersion can be triggered based on factors other than user gestures. In at least one implementation, a noise detected by the device may trigger the transition from the first state of immersion to the second state of immersion. For example, the device may detect a loud noise that transitions the content from the first state of immersion to the second state of immersion. In at least one additional implementation, the device may track the movement of the user gaze to identify the transition from the first state of immersion to the second state of immersion. For example, suppose the user gaze quickly transitions from viewing the content to focusing on an object in the physical world or outside of the content. In that case, the device can be configured to transition from the first state of immersion to the second state of immersion.

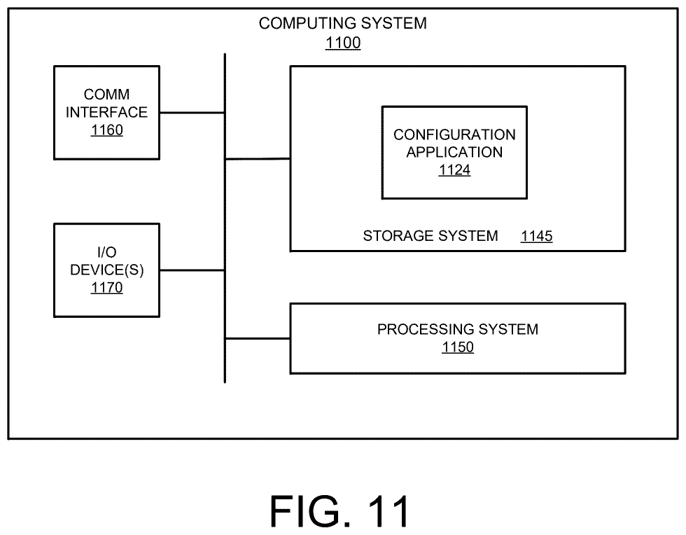

FIG. 11 illustrates a computing system 1100 according to an implementation. Computing system 1100 is representative of any computing system or systems with which the various operational architectures, processes, scenarios, and sequences disclosed herein for dynamically displaying content may be implemented. Computing system 1100 is an example of an XR device, wearable device, or some other computing device capable of the operations described herein. Computing system 1100 includes storage system 1145, processing system 1150, communication interface 1160, and input/output (I/O) device(s) 1170. Processing system 1150 is operatively linked to communication interface 1160, I/O device(s) 1170, and storage system 1145. In some implementations, communication interface 1160 and/or I/O device(s) 1170 may be communicatively linked to storage system 1145. Computing system 1100 may further include other components, such as a battery and enclosure, that are not shown for clarity.

Communication interface 1160 comprises components that communicate over communication links, such as network cards, ports, radio frequency, processing circuitry (and corresponding software), or some other communication devices. Communication interface 1160 may be configured to communicate over metallic, wireless, or optical links. Communication interface 1160 may be configured to use Time Division Multiplex (TDM), Internet Protocol (IP), Ethernet, optical networking, wireless protocols, communication signaling, or some other communication format—including combinations thereof. Communication interface 1160 may be configured to communicate with external devices, such as servers, user devices, or other computing devices.

I/O device(s) 1170 may include computer peripherals that facilitate the interaction between the user and computing system 1100. Examples of I/O device(s) 1170 may include keyboards, mice, trackpads, monitors, displays, printers, cameras, microphones, external storage devices, sensors, and the like.

Processing system 1150 comprises microprocessor circuitry (e.g., at least one processor) and other circuitry that retrieves and executes operating software (i.e., program instructions) from storage system 1145. Storage system 1145 may include volatile and nonvolatile, removable, and non-removable media implemented in any method or technology for storage of information, such as computer-readable instructions, data structures, program modules, or other data. Storage system 1145 may be implemented as a single storage device but may also be implemented across multiple storage devices or sub-systems. Storage system 1145 may comprise additional elements, such as a controller to read operating software from the storage systems. Examples of storage media (also referred to as computer-readable storage media or a computer-readable storage medium) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 1150 is typically mounted on a circuit board that may also hold the storage system. The operating software of storage system 1145 comprises computer programs, firmware, or some other form of machine-readable program instructions. The operating software of storage system 1145 comprises configuration application 1124. The operating software on storage system 1145 may further include an operating system, utilities, drivers, network interfaces, applications, or some other type of software. When read and executed by processing system 1150 the operating software on storage system 1145 directs computing system 1100 to operate as a computing device as described herein. In at least one implementation, the operating software can provide method 200 described in FIG. 2, method 700 described in FIG. 7, or method 1000 described in FIG. 10 as well as any other operation to dynamically change the configuration of content displayed on a wearable device as described herein.

In at least one example, configuration application 1124 directs processing system 1150 to identify a region in a physical environment and cause display of content on a device in a first configuration in response to the device being in the region. Configuration application 1124 further directs processing system 1150 to identify a movement of the device outside of the region and, in response to identifying the movement of the device outside of the region, causing display of the content on the device in a second configuration.

Example clauses related to the aforementioned clauses are provided below.
Clause 1. A method comprising: identifying a region in a physical environment; causing display of content on a device in a first configuration in response to the device being in the region; identifying a movement of the device outside of the region; and in response to identifying the movement of the device outside of the region, causing display of the content on the device in a second configuration.
Clause 2. The method of clause 1 further comprising: in response to identifying the movement of the device outside of the region, pausing display of the content on the device in the first configuration.
Clause 3. The method of clause 1, wherein the first configuration includes a first display size and wherein the second configuration includes a second display size.
Clause 4. The method of clause 3, wherein the second display size is smaller than the first display size.
Clause 5. The method of clause 1, wherein the movement comprises a first movement, and wherein the method further comprises: identifying a second movement of the device from outside of the region into the region; and in response to the second movement, resuming display of the content on the device in the first configuration.
Clause 6. The method of clause 5 further comprising: in response to the second movement, pausing display of the content on the device in the second configuration.
Clause 7. The method of clause 5 further comprising: identifying a gaze associated with a user of the device; and identifying that the gaze satisfies at least one criterion associated with the first configuration; wherein resuming display of the content on the device in the first configuration occurs in response to the second movement and the gaze satisfying the at least one criterion associated with the first configuration.
Clause 8. The method of clause 1, wherein the device comprises a head-mounted device, wherein the first configuration displays the content in a first location on a display of the device, and wherein the second configuration displays the content in a second location on the display.
Clause 9. A computing apparatus comprising: at least one processor; a computer-readable storage medium operatively coupled to the at least one processor; and program instructions stored on the computer-readable storage medium that, when executed by the at least one processor, cause the at least one processor to execute operations, the operations comprising: identifying a region in a physical environment; causing display of content on a device in a first configuration in response to the device being in the region; identifying a movement of the device outside of the region; and in response to identifying the movement of the device outside of the region, causing display of the content on the device in a second configuration.
Clause 10. The computing apparatus of clause 9, wherein the operations further comprise: in response to identifying the movement of the device outside of the region, pausing display of the content on the device in the first configuration.
Clause 11. The computing apparatus of clause 9, wherein the first configuration includes a first display size and wherein the second configuration includes a second display size.
Clause 12. The computing apparatus of clause 11, wherein the second display size is smaller than the first display size.
Clause 13. The computing apparatus of clause 9, wherein the movement comprises a first movement, and wherein the operations further comprise: identifying a second movement of the device from outside of the region into the region; and in response to the second movement, resuming display of the content on the device in the first configuration.
Clause 14. The computing apparatus of clause 13, wherein the operations further comprise: in response to the second movement, pausing display of the content on the device in the second configuration.
Clause 15. The computing apparatus of clause 13, wherein the operations further comprise: identifying a gaze associated with a user of the device; and identifying that the gaze satisfies at least one criterion associated with the first configuration; wherein resuming display of the content on the device in the first configuration occurs in response to the second movement and the gaze satisfying the at least one criterion associated with the first configuration.
Clause 16. The computing apparatus of clause 9, wherein the device comprises a head-mounted device, wherein the first configuration displays the content in a first location on a display of the device, and wherein the second configuration displays the content in a second location on the display.
Clause 17. A computer-readable storage medium having program instructions stored thereon that, when executed by at least one processor, cause the at least one processor to execute operations, the operations comprising: causing display of content in a first configuration on a device; identifying a location associated with the device; identifying a gaze associated with a user of the device; determining that the location and the gaze satisfy at least one criterion; and in response to the location and the gaze satisfying the at least one criterion, causing display of the content in a second configuration in place of the first configuration.
Clause 18. The computer-readable storage medium of clause 17, wherein the first configuration comprises a first size and a first location on a display of the device, and wherein the second configuration comprises a second size and a second location on the display of the device.
Clause 19. The computer-readable storage medium of clause 17, wherein causing display of the content in the first configuration on the device comprises: determining a location on a display for the content based on the gaze; and causing display of the content in the location on the display.
Clause 20. The computer-readable storage medium of clause 17, wherein the first configuration comprises first size and the second configuration comprises a second size, and wherein the first size is smaller than the second size.

In this specification and the appended claims, the singular forms “a,” “an” and “the” do not exclude the plural reference unless the context dictates otherwise. Further, conjunctions such as “and,” “or,” and “and/or” are inclusive unless the context dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections, or logical connections may be present in a practical device. Moreover, no item or component is essential to the practice of the implementations disclosed herein unless the element is specifically described as “essential” or “critical.”

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, the use of terms such as up, down, top, bottom, side, end, front, back, etc. herein are used concerning a currently considered or illustrated orientation. If they are considered concerning another orientation, such terms must be correspondingly modified.

Further, in this specification and the appended claims, the singular forms “a,” “an” and “the” do not exclude the plural reference unless the context dictates otherwise. Moreover, conjunctions such as “and,” “or,” and “and/or” are inclusive unless the context dictates otherwise. For example, “A and/or B” includes A alone, B alone, and A with B.

Although certain example methods, apparatuses, and articles of manufacture have been described herein, the scope of coverage of this patent is not limited thereto. It is to be understood that the terminology employed herein is to describe aspects and is not intended to be limiting. On the contrary, this patent covers all methods, apparatus, and articles of manufacture fairly falling within the scope of the claims of this patent.

1. A method comprising:
causing display of content on a device in a first configuration, the first configuration including a first size for the content;
identifying a location associated with the device;
identifying a gaze associated with a user of the device;
determining that the location and the gaze satisfy at least one criterion; and
in response to the location and the gaze satisfying the at least one criterion, causing display of the content on the device in a second configuration in place of the first configuration, wherein the second configuration includes a second size for the content larger than the first size.

2. (canceled)

3. The method of claim 1, wherein the first configuration includes a first location and wherein the second configuration includes a second location.

4. The method of claim 3, wherein the second location is more central in the gaze of the user than the first location.

5. The method of claim 1, wherein the location comprises a first location, wherein the method further comprises:
identifying a second location of the device; and
in response to identifying the second location, causing display of the content on the device in the first configuration in place of the second configuration.

6. The method of claim 1, further comprising:
determining that the gaze satisfies at least one additional criterion; and
in response the gaze satisfying the at least one additional criterion, causing display of the content on the device in the first configuration in place of the second configuration.

7. The method of claim 1, wherein the at least one criterion comprises a region associated with the second configuration.

8. The method of claim 1, wherein the device comprises a head-mounted device, wherein the at least one criterion comprises an angle associated with the gaze relative to a surface for the content.

9. A computing apparatus comprising:
at least one processor;
a computer-readable storage medium operatively coupled to the at least one processor; and
program instructions stored on the computer-readable storage medium that, when executed by the at least one processor, cause the at least one processor to execute operations, the operations comprising:
causing display of content on a device in a first configuration, the first configuration including a first size for the content;
identifying a location associated with the device;
identifying a gaze associated with a user of the device;
determining that the location and the gaze satisfy at least one criterion; and
causing display of the content on the device in a second configuration in place of the first configuration based on the location and the gaze satisfying the at least one criterion, wherein the second configuration includes a second size for the content larger than the first size.

10. (canceled)

11. The computing apparatus of claim 9, wherein the first configuration includes a first location and wherein the second configuration includes a second location.

12. The computing apparatus of claim 11, wherein the second location is more central in the gaze of the user than the first location.

13. The computing apparatus of claim 9, wherein the location comprises a first location, and wherein the operations further comprise:
identifying a second location of the device; and
in response to identifying the second location, causing display of the content on the device in the first configuration in place of the second configuration.

14. The computing apparatus of claim 9, wherein the operations further comprise:
determining that the gaze satisfies at least one additional criterion; and
in response to the gaze satisfying the at least one additional criterion, causing display of the content on the device in the first configuration in place of the second configuration.

15. The computing apparatus of claim 9, wherein the at least one criterion comprises a region associated with the second configuration.

16. The computing apparatus of claim 9, wherein the device comprises a head-mounted device, wherein the at least one criterion comprises an angle associated with the gaze relative to a surface for the content.

17. A non-transitory computer-readable storage medium having program instructions stored thereon that, when executed by at least one processor, cause the at least one processor to execute operations, the operations comprising:
causing display of content in a first configuration on a device, the first configuration including a first size for the content;
identifying a location associated with the device;
identifying a gaze associated with a user of the device;
determining that the location and the gaze satisfy at least one criterion; and
in response to the location and the gaze satisfying the at least one criterion, causing display of the content in a second configuration in place of the first configuration, wherein the second configuration includes a second size for the content larger than the first size.

18. The non-transitory computer-readable storage medium of claim 17,
wherein the first configuration comprises a first location on a display of the device,
wherein the second configuration comprises a second location on the display of the device.

19. The non-transitory computer-readable storage medium of claim 17, wherein causing display of the content in the first configuration on the device comprises:
determining a location on a display for the content based on the gaze; and
causing display of the content in the location on the display.

20. The non-transitory computer-readable storage medium of claim 17, wherein at least one criterion comprises an angle associated with the gaze relative to a surface for the content.
